(19) United States
(12) Patent Application Publication
(10) Pub. No.: US 2014/0085291 A1
(43) Pub. Date: Mar. 27, 2014

(54) DRIVE DEVICE FOR LIQUID CRYSTAL DISPLAY DEVICE, AND LIQUID CRYSTAL DISPLAY DEVICE

(71) Applicant: Kyocera Display Corporation, Yasu-shi (JP)

(72) Inventor: Kenji GONDO, Yasu-shi (JP)

(73) Assignee: Kyocera Display Corporation, Yasu-shi (JP)

(21) Appl. No.: 14/089,119

(22) Filed: Nov. 25, 2013

Related U.S. Application Data
(63) Continuation of application No. PCT/JP2012/062221, filed on May 11, 2012.

(30) Foreign Application Priority Data
May 25, 2011 (JP) 2011-116493

(51) Int. Cl. G09G 3/36

(52) U.S. Cl. CPC G09G 3/3696
USPC 345/212; 345/87

(57) ABSTRACT

A power supply IC adjusts the frequency of a clock signal outputted from an EXT terminal such that the voltage inputted into a VFB terminal turns to a desired voltage. The power supply IC outputs a clock signal when the control signal inputted into the OE terminal is turned on. The control unit turns on the control signal only in a period that has a time length obtained by adding a slight allowance time to the period required for completion of pixel charge and turns off the control signal upon lapse of the time length. Thus, the power supply circuit outputs an analog voltage only in an initial part in one horizontal period and outputs no analog voltage in the remaining part of the one horizontal period.

### TECHNICAL FIELD

The present invention relates to a drive device for a liquid crystal display device and a liquid crystal display device, which are capable of reducing power consumption.

### BACKGROUND ART

In a liquid crystal display panel using TFTs (Thin Film Transistors), a TFT is disposed in each intersectional position of gate lines and source lines such that the source and the drain of the TFT are placed in a conductive state therebetween when a gate-on voltage of V_{GH} is applied to the relevant gate line. Data is written into the pixel (specifically pixel capacity and storage capacity) connected to the drain by applying a data voltage according to display data to the source line in that state.

A drive device for a liquid crystal display panel includes a source driver for applying data voltages to source lines. The device for a liquid crystal display panel also includes a gradation voltage generation circuit for generating data voltages according to display data. The source driver is generally realized as a source driver IC.

In this case, the gradation voltage generation circuit is disposed independently from the source driver IC or incorporated into the source driver IC.

A liquid crystal display device is incorporated into mobile devices or a variety of other devices, which are required to have power consumption reduced by reducing the power consumption of such a liquid crystal display device. In order to reduce the power consumption of such a liquid crystal display device, a drive device has been proposed to reduce the output current of a source driver IC (see, e.g. Patent Document 1).

In the drive device disclosed in Patent Document 1, the output of the source driver IC is placed in an enabled state only in a period for writing data into pixels while the output of the source driver IC is placed in a disabled state in a period for holding a pixel capacity and a storage capacity.

### PRIOR ART DOCUMENTS

### Patent Documents

Patent Document 1: JP-A-11-338433

### DISCLOSURE OF INVENTION

### Technical Problem

The drive device disclosed in Patent Document 1 aims at reducing the power consumption of a liquid crystal display device by controlling the output of a source driver IC. The operation of the source driver IC itself is, however, not completely prohibited even when the output of the source driver IC is placed in a disabled state. Thus, the source driver IC consumes power to some extent even when the output of the source driver IC is placed in a disabled state. In other words, it is questionable that the drive device has achieved a sufficient reduction in power consumption.

It is an object of the present invention to provide a drive device for a liquid crystal display device and a liquid crystal display device, which are capable of further reducing power consumption.

### Solution To Problem

The present invention provides a drive device for driving a liquid crystal display device, which includes a power supply circuit for supplying power to an analog circuit in the drive device, and which further includes the power supply circuit comprising a control unit for substantially stopping power supply to the analog circuit in a non-operation period excluding a period corresponding to a writing period for writing data into pixels of the liquid crystal display panel in a horizontal period.

The non-operation period is, e.g. a period excluding a period starting with a time from the lapse of a last horizontal period to the commencement of the next horizontal period and ending with a time that has a time length obtained by adding an additional allowance time to a period required for completion of writing data into pixels.

The power supply circuit includes a power supply IC which outputs a clock signal having a frequency corresponding to a desired voltage (such as an analog voltage of 13 V) to a switching element connected to a booster coil and which has a control terminal for controlling the output/non-output of the clock signal. The control unit may be configured to have a first control unit which outputs a control signal indicating the non-output of the clock signal to the control terminal of the power supply IC in the non-operation period.

The power supply circuit may be configured to include a booster coil, a switching element (such as a FET) for switching a current flowing in the booster coil, and a diode (such as a diode) with an induced voltage of the booster coil being applied thereto. The control unit may be configured to have a second control unit which outputs a control signal for blocking the output of the diode (such as turning off an FET) in the non-operation period.

It is preferred that the control unit output the control signal in a vertical blanking period (i.e. turns on the control signal).

The present invention also provides a liquid crystal display device which includes the above-mentioned drive device and a liquid crystal display panel.

### Advantageous Effects of Invention

In accordance with the present invention, it is possible to further reduce the power consumption of a liquid crystal display device.

### BRIEF DESCRIPTION OF DRAWINGS

FIG. 1 is a block diagram showing a structural example of a liquid crystal display device with a drive device according to the present invention mounted thereon.

FIG. 2 is a circuit diagram showing a structural example of a power supply circuit in the drive device as well as a source driver and a gradation generating circuit in a first embodiment of the present invention.

FIG. 3 is a timing chart showing an example of the state of each of a control signal and V_{DDA} as well as an STB signal and output to a liquid crystal in the first embodiment of the present invention.

FIG. 4 is a circuit diagram showing a structural example of a power supply circuit in the drive device as well as a source driver and a gradation generating circuit in a second embodiment of the present invention.

FIG. 5 is a circuit diagram showing a structural example of a power supply circuit as well as a source driver and a gradation generating circuit as a comparative example.

### DESCRIPTION OF EMBODIMENTS

Now, embodiments of the present invention will be described in reference to the accompanying drawings.

### Embodiment 1

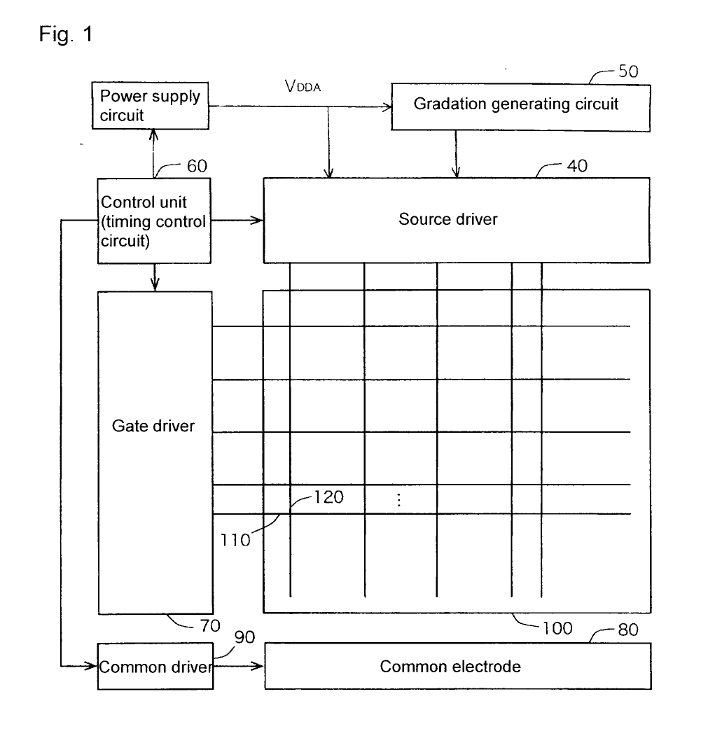

FIG. 1 is a block diagram showing a structural example of a liquid crystal display device with a drive device according to the present invention mounted thereon. The liquid crystal display device shown in FIG. 1 includes a liquid crystal display panel 100 having many pixels (not shown) disposed in a matrix pattern thereon. In order to form the pixels, many gate lines 110 are disposed in a horizontal direction (a row direction) while many source lines 120 are disposed in a column direction so as to apparently cross the gate lines 110. A TFT (not shown) is disposed in each intersectional position of the gate lines 110 and the source lines 120. The drain electrode of the TFT (not shown) is connected to the relevant pixel electrode.

An opposed substrate (not shown) is disposed in a position opposite to a substrate with the gate lines 110, the source lines 120 and the pixels disposed thereon, and a liquid crystal is sandwiched between the opposed substrate and the substrate with the pixels disposed thereon. The opposed substrate has a common electrode 80 disposed thereon. A common driver 90 supplies a common voltage V_{COM} to the common electrode 80 such that the common electrode 80 is set at the common voltage. A gate driver 70 line-sequentially drives the gate lines 110 based on a signal outputted from a control unit (timing control circuit) 60. A source driver 40 applies, through the source lines 120, data voltages (voltages corresponding to a data signal) V_{D} to the pixel electrodes that are located at the pixels connected to a selected gate line 110, i.e. a gate line 110 with a gate-on voltage V_{GH} applied thereto.

It should be noted that the source driver 40, the gate driver 70, the common driver 90 and the timing control circuit 60 shown in FIG. 1 are all constituent elements of the drive device for a liquid crystal display panel. The common driver 90 may be incorporated into a power supply circuit (not shown).

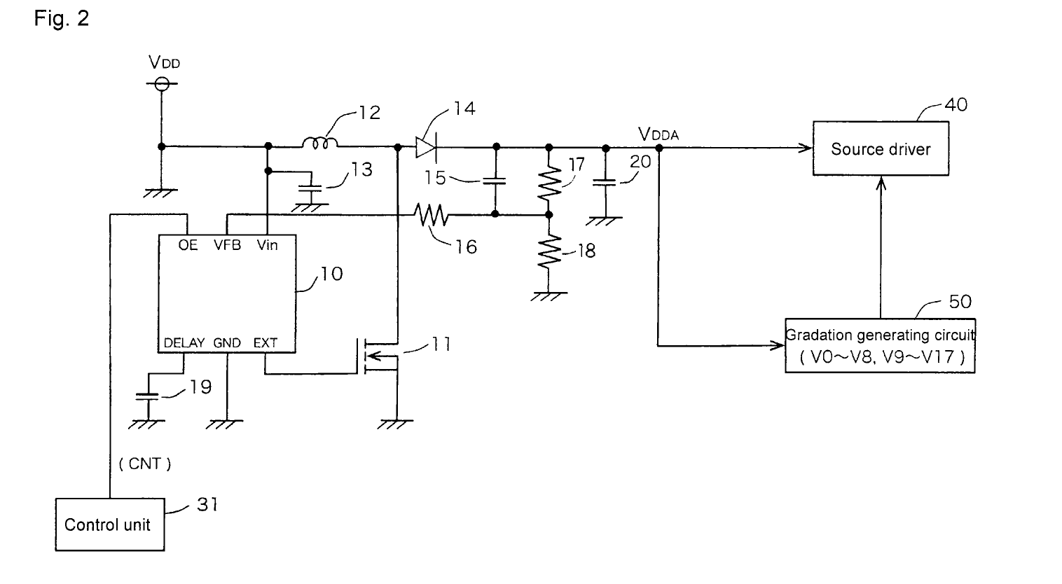

FIG. 2 is a circuit diagram showing a structural example of the power supply circuit in the drive device as well as the source driver 40 and a gradation generating circuit (gradation voltage generation circuit) 50 in a first embodiment of the present invention. Explanation of this embodiment will be made about a case where the gradation generating circuit 50 is a circuit for generating reference gradation voltages V0 to V8 having a negative polarity and reference gradation voltages V9 to V17 having a positive polarity based on an input voltage V_{DDA} (such as 13 V: hereinbelow, also referred to analog voltage).

Each of the source driver 40 and the gradation generating circuit 50 will be also called analog circuits later on because of including a circuit dealing with an analog voltage. Only a portion of each of the source driver 40 and the gradation generating circuit 50 that deal with an analog voltage may be defined as an analog circuit.

The power supply circuit includes a power supply IC 10. The power supply IC 10 has a delay terminal (DELAY terminal) connected to a capacitor 19. The power supply IC has an output enabled terminal (OE terminal) receiving a control signal (CNT) outputted from a control unit (first control unit) 31. It should be noted that the first control unit 31 may be included in the control unit 60 shown in FIG. 1.

The power supply IC has a power input terminal (Vin terminal) receiving V_{DD} (such as 5 V: hereinbelow, also referred to digital voltage) and connected to a capacitor (bypass capacitor) 13. The digital voltage is supplied to one end of a coil 12. The other end of the coil is connected to a FET 11. The FET 11 is switched by a clock signal outputted from an output terminal (EXT terminal) of the power supply IC 10.

The induced voltage of the coil is applied across a diode 14, from which an analog voltage V_{DDA} is outputted. The analog voltage V_{DDA} is divided by resistors 17 and 18, and is inputted into a feedback terminal (VFB terminal) of the power supply IC 10 through a resistor 16. The power supply IC 10 adjusts, based on a potential defined by the VFB terminal, the frequency of a clock signal outputted from the EXT terminal such that the analog voltage V_{DDA} turns to a desired voltage. There is also disposed a capacitor 15 as a speed-up capacitor, through which a ripple caused by a load fluctuation in the output voltage is fed back to the VFB terminal.

The analog voltage V_{DDA} is smoothed by a smoothing capacitor 20, followed by being supplied to the analog circuits (the source driver 40 and the gradation generating circuit 50). In other words, an electric charge (electric current) is supplied to the analog circuits through the smoothing capacitor 20. Thus, an electric current is supplied to the analog circuits from the smoothing capacitor 20 in a period where the power supply circuit outputs no analog voltage.

The power supply IC 10 outputs a clock signal when the control signal (CNT) inputted into the OE terminal is turned on (for example, at a high level). In other words, the power circuit is capable of outputting a certain analog voltage when the control signal (CNT) inputted into the OE terminal is turned on. The power supply IC 10 outputs no clock signal when the control signal (CNT) inputted into the OE terminal is turned off (for example, at a low level). In a case where the diode has a forward drop voltage of, e.g. Vf, when the control signal (CNT) inputted into the OE terminal is turned off, the power circuit provides an output of V_{DD}-Vf, which fails to reach the level of an output for causing the analog circuits to be properly driven. Thus, the analog circuits are substantially placed in an inoperative state.

In the structure shown in FIG. 2, the power supply circuit is disposed at the pre-stage of the smoothing capacitor 20.

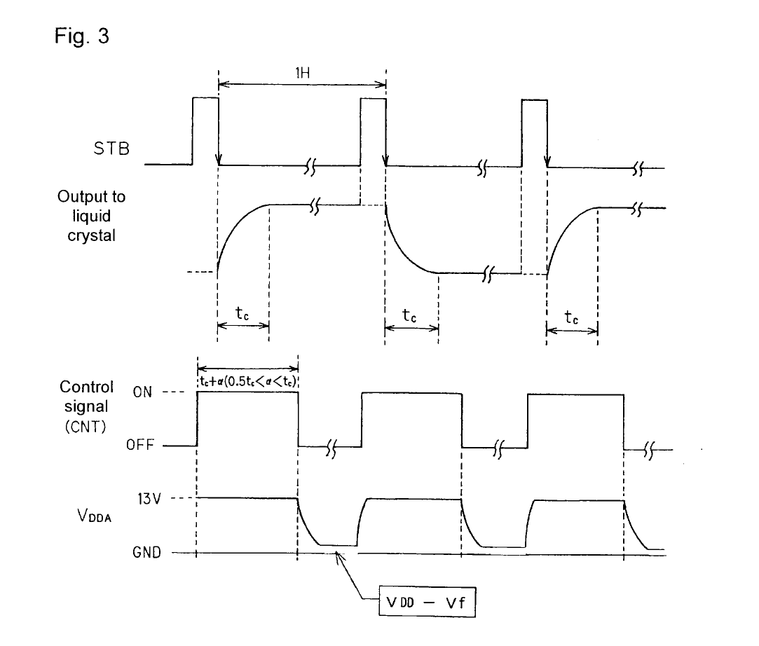

Now, the operation of the power supply circuit in the drive device according to this embodiment will be described. FIG. 3 is a timing chart showing an example of the state of each of the control signal and V_{DDA} as well as an STB signal (strobe signal corresponding to a latch pulse) and output to a liquid crystal. The STB signal is a control signal which is outputted from the control unit 60 to the source driver 40 and which designates the selection period of each row. The source driver 40 is placed in a state to be capable of driving a source line when the STB single is turned on (for example, is at a low level). The output to the liquid crystal in FIG. 3 corresponds to the voltage of a pixel. 1H means one horizontal period.

As shown in FIG. 3, the first control unit 31 turns on the control signal (CNT) before the STB single corresponding to each horizontal period is turned on. In each horizontal period, the first control unit turns off the control signal (CNT) at a later time than the lapse of a period of t_{c}. The period of t_{c} is a period required for completion of pixel charge.

In this embodiment, it should be noted that the first control unit 31 starts turning on the control signal (CNT) while the STB signal is turned off (for example, is at a high level). It is sufficient that the control signal (CNT) has been turned on before the STB signal is turned on. For example, the first control unit 31 may start turning on the control single (CNT) while the STB single is turned off in a last horizontal period. The reason why the control signal (CNT) is turned on before the STB single is turned on is that the output of the analog voltage is stabilized before the STB signal is turned on.

In order that the output of the analog voltage is prevented from lowering before completion of pixel charge (before the lapse of the period of t_{c}), the period where the control signal (CNT) is turned on is set to be longer than the period of t_{c}. As an example, the period where the control signal (CNT) is turned on is set at a value from 1.5 t_{c} to 2.0 t_{c}. It should be noted that the period from a time when the STB signal is turned on to a time when the period of t_{c} passes is included in the period where the control signal (CNT) is turned on as shown in FIG. 3.

In this embodiment, the first control unit 31 turns on the control signal (CNT) only in a period that has a time length obtained by adding a slight allowance time to the period required for completion of pixel charge, and turns off the control signal (CNT) upon lapse of the time length. Thus, the power supply circuit outputs an analog voltage only in an initial part in one horizontal period and outputs no analog voltage in the remaining part of the one horizontal period. As a result, the output is V_{DD}-Vf in the case shown in FIG. 2.

In other words, the first control unit 31 controls the power supply IC 10 so as to substantially stop power supply to the analog circuits in a non-operation period excluding a period corresponding to a period for writing data into pixels in a horizontal period. Specifically, the first control unit controls the power supply IC 10 so as to substantially stop power supply to the analog circuits in a period (non-operation period) excluding a period (operation period) starting with a time from the lapse of a last horizontal period to the commencement of the next horizontal period and ending with the lapse of a period that has a time length obtained by adding a certain allowance time to a period for completion of data writing.

Thus, the circuits dealing with an analog voltage in the source driver 40 are supplied with an analog voltage only in the initial part of one horizontal period and are supplied with no analog voltage in the remaining part of the one horizontal period. The circuits dealing with an analog voltage is placed in a non-operating state when being supplied with no analog voltage, with the result that the power consumption in the source driver 40 is reduces. It should be noted that the source driver 40 does not drive the source lines when being supplied with no analog voltage. Specifically, the source driver places the source lines in a high impedance state. It is not necessary to supply the source driver with a gradation voltage in a period where the source driver 40 does not drive the source lines, and the gradation generating circuit 50 is also supplied with no analog voltage in that period, with the result that the power consumption in the gradation generating circuit 50 is also reduced. It should be noted that it is preferred that the power supply circuit output no analog voltage in the entire horizontal period in the vertical blanking period of each screen. In other words, it is preferred that the first control unit 31 constantly output (turns on) the control signal (CNT) in the vertical blanking period.

### Embodiment 2

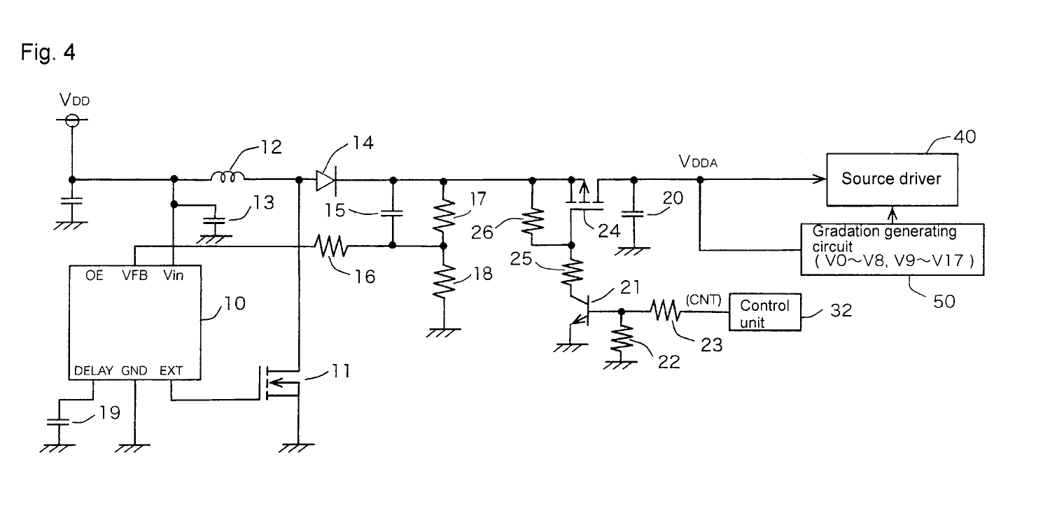

FIG. 4 is a circuit diagram showing a structural example of a power supply circuit in the drive device as well as a source driver 40 and a gradation generating circuit 50 in a second embodiment of the present invention.

In the power supply circuit shown in FIG. 4, a power supply IC has an OE terminal, the input state of which is not subject to control. In other words, no control signal (CNT) is inputted into the OE terminal. Thus, in this embodiment, the induced voltage of a coil is constantly outputted as a certain boost voltage through a diode, which is different from the first embodiment.

The power supply circuit has a circuit disposed at the pre-stage of a soothing capacitor 20 in order to control the voltage application to the soothing capacitor 20. Specifically, the power supply circuit has a transistor 21 and a p-channel FET 24 such that the transistor is switched by a voltage given by dividing the voltage of a control single outputted from a control unit (second control unit) 32 by resistors 22 and 23, and the FET has a gate supplied with a voltage given by dividing V_{DD} by resistors 25 and 26 when the transistor 21 conducts. The transistor 21 conducts when the control signal (CNT) is at a high level (turns on). When the transistor 21 conducts, the voltage applied to the gate of the FET lowers from V_{DD}, resulting the FET 24 to conduct such that V_{DDA} is applied to the soothing capacitor 20.

Accordingly, at the same timing as the first embodiment (see FIG. 3), the second control unit 32 can turn on the control signal (CNT) to supply an analog voltage to the source driver 40 and the gradation generation circuit 50 and can turn off the control signal (CNT) to supply no analog voltage to the source driver 40 and the gradation generating circuit 50.

In other words, at the same timing as the first embodiment shown in FIG. 3, the second control unit 32 can control the on and off of the control signal (CNT) to obtain a similar advantage to the first embodiment. In the second embodiment as well, it is preferred that the second control unit 32 constantly output (turns on) the control signal (CNT) in the vertical blanking period.

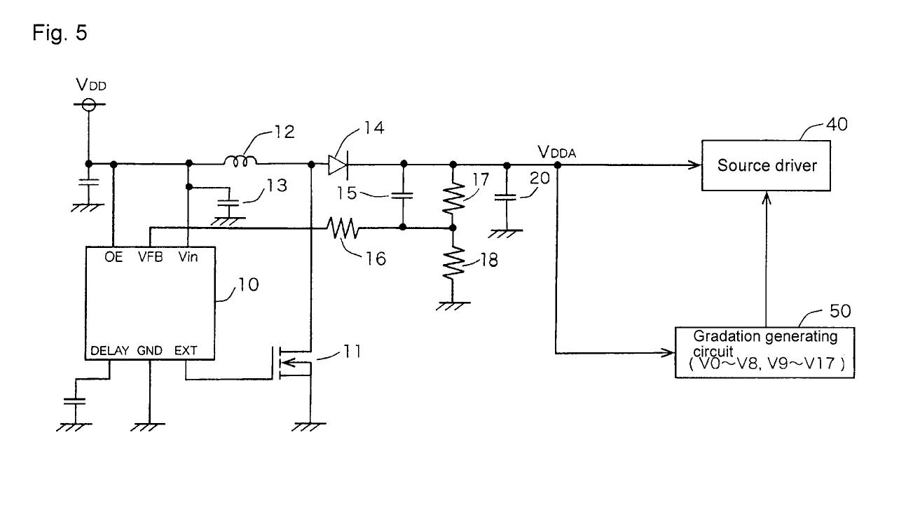

FIG. 5 is a circuit diagram showing a structural example of a power supply circuit as well as a source driver 40 and a gradation generating circuit 50 as a comparative example.

In the power supply circuit shown in FIG. 5, a power supply IC has an OE terminal constantly supplied with V_{DD}. Thus, the power supply circuit constantly outputs an analog voltage. The circuit shown in FIG. 5 has no circuit for switching the analog voltage (which is disposed in the second embodiment).

Accordingly, the source driver 40 and the gradation generating circuit 50 are constantly supplied with V_{ADA}. As a result, the source driver 40 has a certain current (such as 21 mA) constantly flowing therethrough while the gradation generating circuit 50 has a certain current (such as 5 mA) constantly flowing therethrough.

In the first and second embodiments as described above, when the period where the control signal (CNT) is turned on by the first control unit 31 and the second control unit 32 is ⅔ of the entire period, the source driver in each embodiment has a current of an average of about 3 mA flowing therethrough. In other words, each of the first and second embodiments can reduce the current flowing through the source driver 40 and the gradation generating circuit 50, resulting the power consumption in each of the source driver 40 and the gradation generating circuit 50 to reduced. Furthermore, unlike the drive device disclosed in Patent Document 1, the drive device according to each of the first and second embodiments described above can further reduce the power consumption of a liquid crystal display device in comparison with the prior art because the source driver 40 and the circuit to deal with an analog voltage in the gradation generating circuit 50 are substantially inoperative when the control signal (CNT) is turned on. In addition, in order to realize a further reduction in power consumption, the second control unit 32 according to the second embodiment may be added to the first embodiment to control the control signal (CNT).

Although the gradation generating circuit 50 is disposed independently of the source driver 40 in each of the first and second embodiments described above, the present invention is also applicable to a case where the gradation generating circuit 50 is incorporated in the source driver 40.

Although explanation of the first and second embodiments described above has been made about a case where the liquid crystal display panel 100 is a normal TFT display panel, the present invention is also applicable to a TFT display panel driven by an in-plane switching mode, or an STN (Super Twisted Nematic) or TN display panel driven by passive matrix addressing.

### INDUSTRIAL APPLICABILITY

The present invention is applicable to a liquid crystal display device using an analog voltage.

This application is a continuation of PCT Application No. PCT/JP2012/062221, filed on May 11, 2012, which is based upon and claims the benefit of priority from Japanese Patent Application No. 2011-116493 filed on May 25, 2011. The contents of those applications are incorporated herein by reference in its entirety.

What is claimed is:

1. A drive device for driving a liquid crystal display device, including a power supply circuit for supply power to an analog circuit in the drive device and comprising:
the power supply circuit comprising a control unit for substantially stopping power supply to the analog circuit in a non-operation period excluding a period corresponding to a writing period for writing data into pixels of the liquid crystal display panel in a horizontal period.

2. The drive device according to claim 1, wherein the non-operation period is a period excluding a period starting with a time from the lapse of a last horizontal period to the commencement of the next horizontal period and ending with a period that has a time length obtained by adding an additional allowance time to a period required for completion of writing data into pixels.

3. The drive device according to claim 1, wherein the power supply circuit includes a power supply IC which outputs a clock signal having a frequency corresponding to a desired voltage to a switching element connected to a booster coil and which has a control terminal for controlling the output/non-output of the clock signal; and
the control unit has a first control unit which outputs a control signal indicating the non-output of the clock signal to the control terminal of the power supply IC in the non-operation period.

4. The drive device according to claim 2, wherein the power supply circuit includes a power supply IC which outputs a clock signal having a frequency corresponding to a desired voltage to a switching element connected to a booster coil and which has a control terminal for controlling the output/non-output of the clock signal; and
the control unit has a first control unit which outputs a control signal indicating the non-output of the clock signal to the control terminal of the power supply IC in the non-operation period.

5. The drive device according to claim 1, wherein the power supply circuit comprises a booster coil, a switching element for switching a current flowing in the booster coil, and a diode with an induced voltage of the booster coil being applied thereto; and
the control unit has a second control unit which outputs a control signal for blocking the output of the diode in the non-operation period.

6. The drive device according to claim 2, wherein the power supply circuit comprises a booster coil, a switching element for switching a current flowing in the booster coil, and a diode with an induced voltage of the booster coil being applied thereto; and
the control unit has a second control unit which outputs a control signal for blocking the output of the diode in the non-operation period.

7. The drive device according to claim 3, wherein the power supply circuit comprises a booster coil, a switching element for switching a current flowing in the booster coil, and a diode with an induced voltage of the booster coil being applied thereto; and
the control unit has a second control unit which outputs a control signal for blocking the output of the diode in the non-operation period.

8. The drive device according to claim 3, wherein the control unit outputs the control signal in a vertical blanking period.

9. The drive device according to claim 4, wherein the control unit outputs the control signal in a vertical blanking period.

10. The drive device according to claim 5, wherein the control unit outputs the control signal in a vertical blanking period.

11. The drive device according to claim 6, wherein the control unit outputs the control signal in a vertical blanking period.

12. The drive device according to claim 7, wherein the control unit outputs the control signal in a vertical blanking period.

13. A liquid crystal display device comprising the drive device recited in claim 1 and a liquid crystal display panel.
